(19) United States
(12) Patent Application Publication
(10) Pub. No.: US 2025/0346539 A1
(43) Pub. Date: Nov. 13, 2025

(54) METHOD OF MANUFACTURING A VEGETABLE SUBSTRATE, VEGETABLE SUBSTRATE ACTING AS PROLONGED-RELEASE FERTILIZER AND USES THEREOF

(71) Applicants: Edivaldo POCCINELLI, São Paulo (BR); Marcos DE FERRAN, Piracicaba (BR); Leonardo LEONEL SOBRAL, Juiz de Fora (BR); Kenji LEONEL OKA, Juiz de Fora (BR)

(72) Inventors: Edivaldo POCCINELLI, São Paulo (BR); Marcos DE FERRAN, Piracicaba (BR); Leonardo LEONEL SOBRAL, Juiz de Fora (BR); Kenji LEONEL OKA, Juiz de Fora (BR)

(21) Appl. No.: 18/712,899

(22) PCT Filed: Nov. 23, 2021
(86) PCT No.: PCT/IB2021/060860

§ 371 Date: May 23, 2024

(51) Int. Cl. C05F 9/00; C05D 3/02; C05F 11/02

(52) U.S. Cl. CPC C05F 9/00; C05D 3/02; C05F 11/02

(57) ABSTRACT

The present invention is directed to a method of manufacturing a vegetable substrate acting as prolonged-release fertilizer, transforming in an accelerated manner the organic waste into a nutrient-rich organic substrate and humic substances. Further, the patent application refers to the vegetable substrate resulting from said method and the uses thereof, such as prolonged-release fertilizer and soil acidity corrective.

### FIELD OF THE INVENTION

The present invention is directed to a method of manufacturing a vegetable substrate acting as prolonged-release fertilizer, transforming in an accelerated manner the organic waste into a nutrient-rich organic substrate and humic substances. Further, the patent application refers to the vegetable substrate resulting from said method and the uses thereof, such as prolonged-release fertilizer and soil acidity corrective.

### BACKGROUND OF THE INVENTION

The generation of organic waste in our planet has been showing an alarming growth in the last decades and it is known that very little has been done to give same a more noble end, that is, to treat it in a manner as to avoid that it begins to decompose in inappropriate places or without taking advantage of the enormous agricultural potential.

The lack of a destination that enhances the value of the organic waste, in several parts of the planet, leads to a series of environmental (soil pollution, superficial and subterranean waters, emission of methane gas, etc.) and sanitary (proliferation of disease vectors) problems.

Additionally, the placing of this waste in landfills or through incineration (even when legally based), represents a great waste of plant nutrients and humic soil conditioner substances, while the demand for mineral nutrients (extracted from finite deposits, such as phosphorus) only increases. It is important to mention that the anaerobic decomposition of organic substances produces methane gas, which, if not well managed, can be released in the atmosphere contributing to the increase of the greenhouse effect.

The National Policy on Solid Waste (NPSW) presents as one of its objectives the observance of the following priority order: “non-generation, reduction, re-utilization, recycling and treatment of solid waste, as well as the final environmentally-adequate discarding of the rejects” (BRASIL. (2010a) Law no. 12.305, of Aug. 2, 2010. Institutes the National Policy on Solid Waste; alters Law no. 9.605, of Feb. 12, 1998; and makes other provisions. Union Official Gazette, Brasilia, section 1. 3 p.). In its turn, there are only considered rejects “those solid residues wherein all the possibilities of treatment and recovery by the available technological processes and economically viable have been exhausted, whereby the sanitary landfill is the only technology allowed for this purpose” (BRAZIL. (2010a) Law no. 12.305, of Aug. 2, 2010. Institutes the National Policy on Solid Waste; alters Law no. 9.605, of Feb. 12, 1998; and makes other provisions. Union Official Gazette, Brasilia, section 1. 3 p.). Further, the NPSW establishes among the list of technologies for the final environmentally adequate destination of waste: “the reuse, the recycling, the composting, the recovery or other destinations allowed by the competent organizations of the National Environment System (SISNAMA), the National Sanitary Surveillance System (SNVS) and the Unified System of Animal and Plant Health (SUASA), among them the final disposition” (BRAZIL. (2010a) Law no. 12.305, of Aug. 2, 2010. Institutes the National Policy on Solid Waste; alters Law no. 9.605, of Feb. 12, 1998; and makes other provisions. Union Official Gazette, Brasilia, section 1. 3 p.). The composting and the biodigestion (with or without energy conversion) are the technologies most recommended worldwide for the recycling of organic waste (ENVIRONMENTAL SERVICES ASSOCIATION (ESA). (2014) Organics Recycling in a Circular Economy: A Biowaste Strategy from ESA. London: ESA. 20 p.).

This enormous potential has already been recognized by several countries, wherein the management of organic waste is intrinsically connected to the local economy, promoting income, jobs and the mitigation of environmental impact (EUROPEAN COMMISSION. (2015) Assessment of separate collection schemes in the 28 capitals of the EU. Final Report. Brussels: European Commission. 161 p.). In 1999, the biodegradables present in the domestic solid waste were the object of a European Directive relative to landfills, wherein the goal was to reduce the discharge levels of biodegradable waste to 35% between 1995 and 2016 (EUROPEAN COMMISSION. (1999) Directive 1999/31/CE, relative to the disposal of waste in landfills.). More recently, in July 2014, by means of the document “En route to a circular economy: a program for the zero waste”, the European Commission presented a proposal to increase the recycling/reuse of urban waste up to 70% by 2030; progressively eliminate the disposal of recyclable materials in landfills, including organic waste; and reduce the generation of food residues in 30% by 2025, apart from introducing the mandatory selective collection by 2020. Each country jointly assumes these goals and all share the several studies and technologies being developed which will help in meeting these commitments (EUROPEAN COMMISSION (2015) Assessment of separate collection schemes in the 28 capitals of the EU. Final Report. Brussels: European Commission. 161 p.). If met, the goals for the organic waste will have the potential of adding 50 million tons of these materials for recycling and creating at least 100 thousand jobs. The organics, therefore, are the “heart” of the waste circular economy package (EUROPEAN COMPOST NETWORK (ECN). (2015) Re-Thinking the Circular Economy Package. Europe: ECN.).

This entire worldwide reflection coincides with a new urban planning conception which has emerged in the last decades, which proposes a change in the spatial, social and environmental organization of the cities. They are the “sustainable cities”, also named “green cities” or “intelligent cities” (DAMERI, R. P.; ROSENTHAL-SABROUX, C. (2014) Smart City. New York: Springer. 239 p.). In view of the inevitable growth of the urban populations and their demands, it is unavoidable to rethink the sustainability of the cities, which involves the collective sharing of the resources and spaces, to guarantee full life quality to the individuals.

The management of urban waste is a fundamental factor in this new conception of a city, however, if these new paradigms, that are present in the legislations, are not translated into changes in the actual city plan, little will be achieved towards the recommended sustainable management (ZAGO, Valéria Cristina Palmeira; BARROS, Raphael Tobias de Vasconcelos. Management of urban solid waste in Brazil: from the legal order to reality. Eng. Sanit. Ambient., Rio de Janeiro, v. 24, n. 2, p. 219-228, Abr. 2019).

Brazilian patent application BR 102017010980-1 refers to an ultra-fast composting process and the respective final product obtained, belonging to the field of application of recycling methods, transformation and reuse of organic waste, which consists in transforming food waste in rich and fertile fertilizer using automatic methods in appropriate composting machines, by means of the controlled mixture of certain types of ingredients in specific steps, duration, temperature and dosages.

United States Patent U.S. Pat. No. 6,273,927 discloses a method of manufacturing the fertilizer made from organic wastes such as food wastes, human excrements, animal excrements, slaughterhouse waste, hen-house waste, fish and shellfish wastes, vegetable wastes and agricultural wastes. Various wastes are mixed and crushed into certain sizes, processed for adjusting the water content, put into the treating tank and digested by mixing a calcined lime. The referred patent utilizes a dolomite or mixture of calcined lime and dolomite to provide the first treatment material. This first treatment material is mixed with the supplement material such as charcoal, saw dust, loess, zeolite, chaff, or bark powder to give compost fertilizer. It is also mixed with agricultural products such as watermelons or melons which ferment to provide a special fertilizer for the agricultural product The treatment material can be added to water and mixed with mugwort, medicinal herb, zeolite, loess and then extracted to provide a liquid fertilizer As the various organic wastes are changed into organic fertilizer, the acidified soil is improved, the environmental contamination can be prevented, and the high moisturizing and the fine porous of the soil prevent droughts and fertilizer loss SO as to raise fertilizing efficiency.

United States Patent Application US 2019/0337865 describes a horticultural growing medium including a support matrix, the support matrix present in an amount between 60 and 80% by weight and an inorganic component. The organic component includes a moss component including at least 50% by weight moss from the Sphagnum genus which is composed of at least 25% hyaline cells; between 30 and 50% by weight plant derived cellulose fiber component including alone or in any combination: coir, bamboo, hemp, cocoa fiber, rice hulls, and mixtures thereof; and between 0 and 15% cork fiber. The inorganic component includes a particulate igneous volcanic material component including at least one of amorphous volcanic glass, volcanic rock. The horticultural growing medium also includes an organic soil constituent present in an amount between 20 and 40% by weight that includes between 30% and 70% by weight humus soil; between 30% and 70% vermicompost; and up to 5% by weight mammalian derived fecal matter.

Brazilian Patent PI 9705985-4 refers to a composting technique for organic matter waste by means of static aerated piles, wherein a mobile unit injects oxygen in the mass to be decomposed, with rigid temperature, moisture and oxygen content control, reducing the oxidation time of the organic matter from 160 to up to 30 days, free of invaders, development of a diversified microbiotic population, reduction of the physical space for the composting, elimination of heavy machinery, reduction of labor, improvement in the final product quality, maintaining an aerobic activity, by which method there is achieved a better temperature distribution due to the need to remove the heat produced, by the microbiotic activity to adjust the desired temperature, and also to provide the quantity of oxygen required for this microbiological activity, the organic matter composting being carried out with abundance of oxygen, and the decomposition, apart from being quicker, is better conducted, eliminating the bad odor and insect proliferation.

Brazilian Patent PI 9816124-5 refers to a process for the treatment of industrial, urban and hospital waste by means of sorting, composting and incineration by means of a pyrolytic process, with correct environmental solution, combining cost/benefit, in a more secure and economic manner for waste elimination, without odor, without smoke and without emission of particulates. It presents as a principle the waste incineration by the process named pyrolysis, wherein the waste itself is the fuel of the incinerators used in the process, thus eliminating the need for the creation of sanitary landfills.

Brazilian Patent PI 9900912-9 presents a process for obtaining waste compost, from the decanting in perforated tubes for the separation of phases, which process is developed to promote the separation of the waste phases, by means of a decanter of the model “adapted drying ditch”, with the installation in the interior thereof of perforated tubes, used as filter elements. Having established the efficiency of the separation of phases, with the removal of more than 50% of waste, the possibility of distributing the decanted waste was explored by means of the perforated tubes promoting the oxidation of the biodegradable solids and beginning the composting thereof. The final product obtained has low moisture and is stabilized, that is, it has reduced environmental impact potential and has a valued use potential in agriculture eliminating the risks of water pollution, of the soils, and broadening the logistic distribution range. In the perforated tube decanter there are obtained, without the need for movement of the solids to be treated, the decanting and the composting of the waste solids in the same space and without the need for removal, which rationalizes both stages of the process.

Brazilian Patent PI 0207342-0 refers to a continuous liquid composting process for the production of biofertilizer based on the composting (fermenting) in liquid medium, in a continuous manner and carried out in the same tank, by means of the use of an organic compound especially developed and the addition of extra materials, without the interruption of the production, or construction of extra tanks, and allowing to discipline and guide the fermentation, avoiding the acidification of the mixture, and without there being, consequently, any alteration in the quality of the final product obtained (biofertilizer). The organic compound is characterized by being formulated with biodynamic preparations made from certain medicinal plants, activating naturally and guiding the fermentation, maintaining continuous the production of primary and secondary metabolics, avoiding the occurrence of the alcoholic fermentation, acid, lactic, etc., enriching nutritionally the fermentation medium, providing substrate and nutrients for the microbiologic activity and subsequent fertilization of plants and soils, as well as organizing the fermentation processes, transmitting vivifying strength to the soil and harmonizing the relations between plants and the environment.

Brazilian Patent PI 0600930-1 describes a process for the treatment of solid waste by means of composting by accelerated forced aeration which comprises the steps of separation and sorting of the solid waste, storing the organic fraction in closed modules for stabilization and sanitization, said organic fraction being maintained for between 20 to 30 days, at a temperature around 90°/198° C.; injection of air and water in the closed modules to promote the aerobic decomposition of the organic matter, drying of the organic waste and elimination of contaminants and odors; sifting of organic matter and screening of non-degradable waste; transfer of the organic matter to the open air for the maturation phase, which comprises cooling and elimination of remaining gases, remaining for 5 to 10 days, compressing the non-degradable waste and storing in a final landfill or, optionally, the non-degradable waste being incinerated by combustion, with gas cleansing.

Finally, Brazilian patent PI 0910087-3refers to an industrial physical-chemical mechanic and pelletizing composting process in the production of biofertilizer, organo-mineral fertilizer and/or organic fertilizer comprised of agricultural and/or agro-industrial waste, combining known principles and equipment for obtaining new results to replace the traditional/conventional biological composting used for obtaining biofertilizer, organo-mineral fertilizer and/or composite organic fertilizer, manufactured and formulated from agro-industrial and/or agricultural waste or co-products. Said process consists in the use of a cooker/autoclave with different stages/layers of heating of the agro-industrial and/or agricultural waste or co-products; followed by extrusion with an injector nozzle with conventional automatic vegetable and/or animal oil sludge injection system, particularly cotton or soy oil sludge; followed by a new pelletizing behavior by means of the substitution of the addition of steam in the pelletizer by the cotton or soy oil sludge added and mentioned in the previous step.

It is widely known that the composting process is the application of a series of technical procedures aiming at enhancing, through aerobic heterotrophic organisms, the decomposition of organic materials, in order to obtain, as quickly as possible, a uniform compost that is similar to soil, however extremely abundant in mineral nutrients and humic substances, capable of reaching an optimized condition for use as compost and/or fertilizers in general. In this same aspect and relative to the state of the art, it is known that similar processes demand an average 24 hours for the reduction of the organic waste, whereby after this long and considerable period, there is carried out, many times in a manual manner, the mixture of the remaining components which will produce the fertilizer, generating differences and inaccuracies in the final result.

The present invention has the purpose of overcoming all the deficiencies of the technologies of the state of the art by means of the development of a method for manufacturing a vegetable substrate acting as prolonged-release fertilizer which allows transforming in a very quick manner, the organic waste generated by nature and by the action of mankind into a nutrient-rich organic substrate and humic substances, without causing the following problems, such as, the release of methane in the atmosphere, the pollution of the soils and of the waters and the proliferation of diseases. Further, the prolonged-release vegetable substrate of the present invention avoids that the waste utilized begins to decompose in an environmentally inadequate manner, generating gases and slurry, also known as percolated or leached liquid which, when not handled in an adequate manner results in a pollutant liquid, with a dark color and nauseating odor, originating from biological, chemical and physical organic residue decomposition processes.

Further, the present invention transforms, in a very quick manner, organic waste, of diverse origins, into an nutrient-rich organic substrate, avoiding environmental impacts to human health and, at the same time, and in an innovative manner, resulting in a vegetable substrate with double effect, as a fertilizer for the gradual release of nutrients over time, with its function maintained for up to five months and as a soil acidity corrective.

### DESCRIPTION OF THE FIGURES

FIG. 1 presents the general flowchart of the method of manufacturing a vegetable substrate of the present invention.

FIG. 2 exhibits the effect of height in plants in centimeters in different phenological stages (vegetative phase), using vegetable soil, Visafértil®, mineral fertilizer and the prolonged-release vegetable substrate (CEXP), of the present invention.

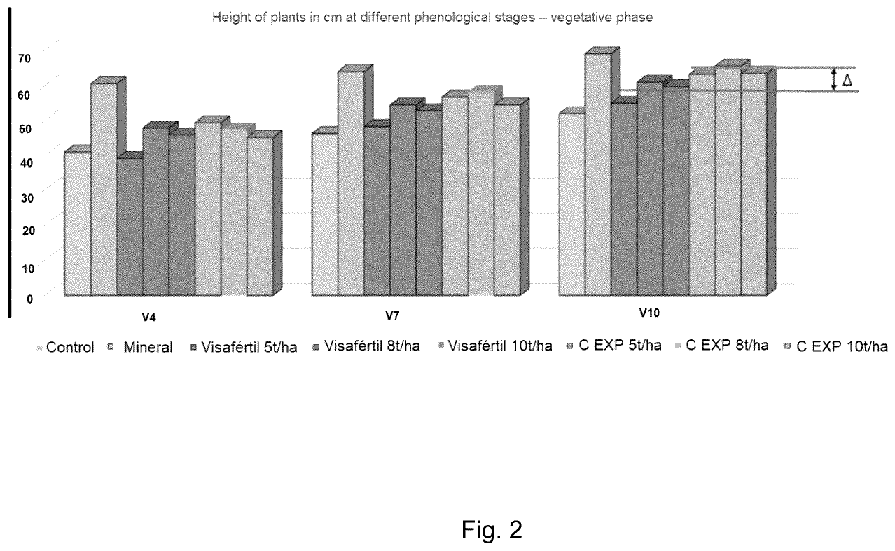

FIG. 3 shows the results of the effect over the weight of the roots, dry mass per g/vegetable soil plant, Visafértil®, mineral fertilizer and the prolonged-release vegetable substrate (CEXP), evidencing the antagonistic effect of the increase of the dose of vegetable substrate of the present invention.

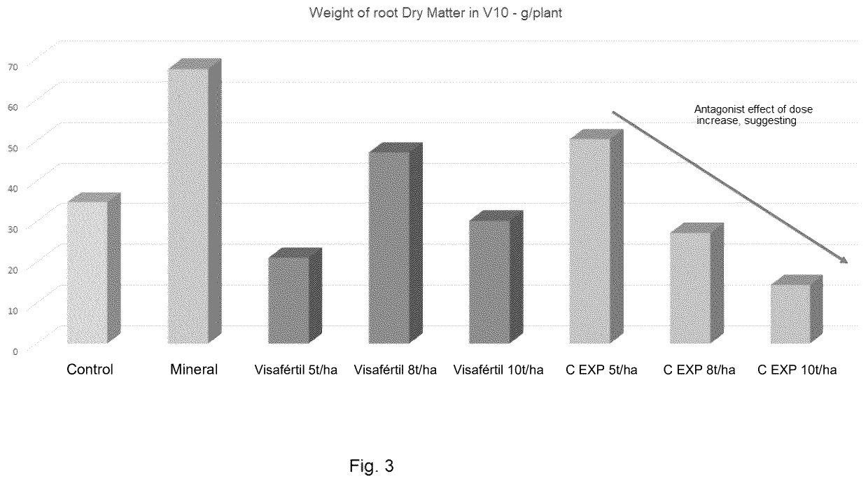

FIG. 4 describes the result of the potassium content (g/Kg) in foliar tissue, using vegetable soil, Visafértil®, mineral fertilizer and the prolonged-release vegetable substrate (CEXP), of the present invention.

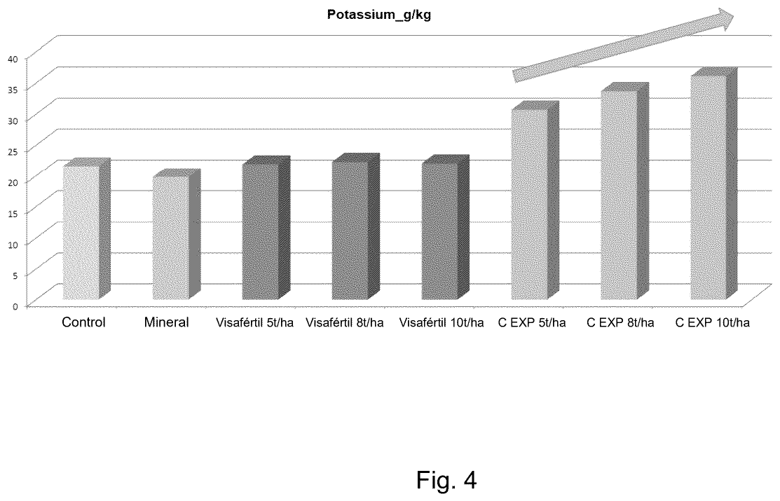

FIG. 5 presents the result of the zinc content (g/Kg) in foliar tissue, using vegetable soil, Visafértil®, mineral fertilizer and the prolonged-release vegetable substrate (CEXP), of the present invention.

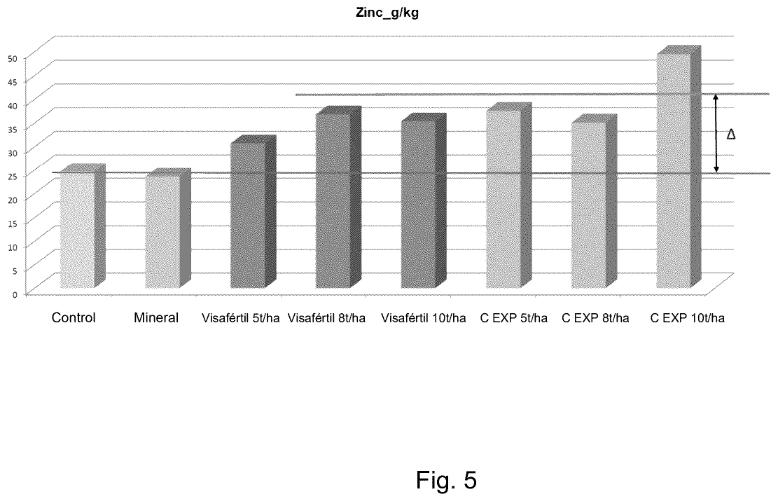

FIG. 6 shows the result of the boron content (g/Kg) in foliar tissue, using vegetable soil Visafértil®, mineral fertilizer and the prolonged-release vegetable substrate (CEXP), of the present invention.

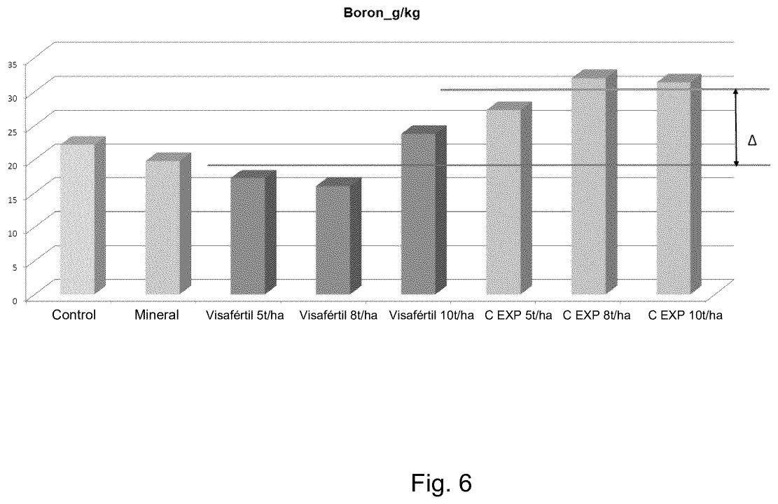

### DESCRIPTION OF THE INVENTION

The present invention is directed to a method of manufacturing a vegetable substrate acting as prolonged-release fertilizer, transforming in an accelerated manner the organic waste into a nutrient-rich organic substrate and humic substances. Further, the patent application refers to the vegetable substrate resulting from said method and the uses thereof, such as prolonged-release fertilizer and soil acidity corrective.

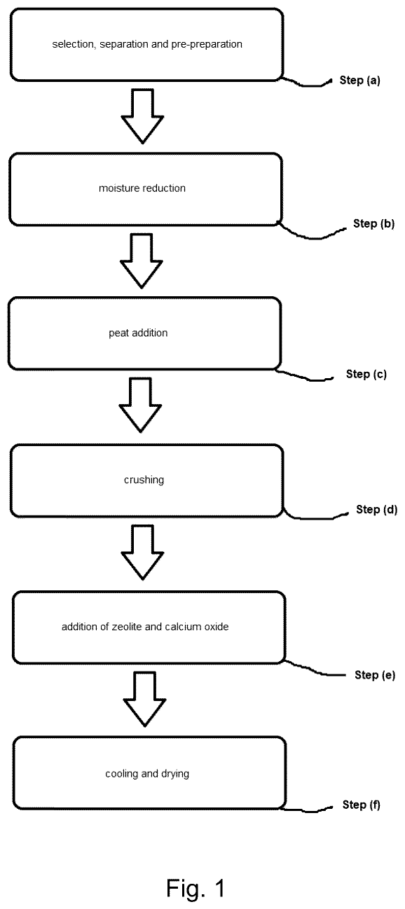

Reference is made to the flow chart of FIG. 1 with steps (a)-Step (f). In a first aspect of the invention, the patent application refers to a method of manufacturing a prolonged-release vegetable substrate comprising the steps of (a) selection, separation and pre-preparation of the organic waste, before beginning the decomposition process of the referred waste, and with a moisture level of around from 50% to 70%; (b) reduction of the moisture of the organic waste to around from 5% to 15% to avoid hydrolysis during the process; (c) addition of 5% to 20% of the total weight of peat, coconut fiber, sawdust and/or combinations thereof to the waste of step (b) at the temperature from 80° C. to 110° C. and stirring between 40 to 60 RPM for around 20 to 40 minutes; (d) crushing of the mixture of step (c) in quantities from 70% to 80% of the total weight of the composition in a granulometry between 1 mm to 30 mm; (e) addition of 2% to 6% of zeolite and 3% to 10% of calcium oxide relative to the total weight of the composition, repeating the steps of mixing, stirring, heating and homogenization of steps (c) and (d), and (f) cooling and drying for one to 4 hours at room temperature.

The organic waste, used in the present invention can be food remains, all kinds of vegetable waste (tree pruning, gardening waste, waste from processing in the foodstuff industry), meat, bones, or even animal excrements.

In step (a) the organic waste selected must be used within 48 hours from the selection and separation thereof and, in case it is necessary to extend this time, they must be stored under refrigeration at a temperature between 2° C. and 6° C., and even in this condition said waste must be processed within up to 72 hours from the selection and separation.

The reduction in moisture in step (b) of the present method is obtained by means of the utilization of an equipment comprising a tank having capacity to homogenize and stir the mixture by means of rotary blades, and further to heat the same by being in contact with a heat exchanger, particularly, of oil heated by electric resistances, which controlled temperature remains between 80° C. to 110° C.

Step (c) of addition of peat, coconut fiber, dry wood chips, sawdust and/or the combinations thereof is carried out preferably, in an internal tank fixed with rotary blades and programmed for reversal of the rotary direction every 10 minutes. Other mixing equipment can also be used. Further, the tank of the equipment also has the ability to heat the mixture by being in contact with a heat exchanger of oil that is heated by electrical resistances, which temperature is controlled. Said controlled temperature is sufficient and necessary to eliminate harmful microorganisms which perchance are present in the mixture. The said mixture is continuously stirred and mixed in the tank for around 20 to 40 minutes, at a speed of 40 RPM to 60 RPM, and preferably, at a temperature of 90° C. (always so as to guarantee the complete elimination of the thermophilic organisms). Additionally in step (c), there is employed an extractor for removal of water steam generated inside the tank during this first cycle, allowing the mixture to become practically dry.

The peat, coconut fiber, dry wood chips, sawdust and/or the combinations thereof added in step (c) are used to retain the water released by the organic waste, which are mostly food remains, fruit and vegetable peels, agricultural waste, meats, bones among others. Further, part of the water contained in the waste at this step will be removed from the mixture in the form of steam, due to the heating supplied by the equipment during the stirring of the waste, so that, at the conclusion of the process, the mixture is presented as a visually dry composite and which has a dry soil texture.

The crushing of step (d) is carried out, preferably, by an equipment with parallel blades whereby other types of crushers and/or grinders for organic waste can be used, particularly, having the ability to grind harder waste, for example, bones.

The zeolite and calcium oxide added in step (e) are in powder form. Being preferably added around 3% of zeolite and around 8% of calcium oxide.

In the second cycle of 30 more minutes stirring, mixing and heating of step (e), completing 60 minutes in both cycles, the calcium oxide aggregates to the organic material particles, forming a coating which will inhibit the decomposition, and thus, avoiding the production of nauseating odors originating from the traditional process. Further, considering that a large volume of water was removed during the process, the possibility of calcium oxide hydrolysis is considerably reduced, there remaining therefore the final product protected from the action of bacteria which will not be able to decompose, thus not generating CO2 nor methane gas, as well as avoiding loss of nitrogen to the atmosphere.

The total cycle necessary for the manufacture of the substrate of the present invention from organic waste is of around three hours, for example, 1 hour processing and approximately 2 hours for drying, the production of large volumes being possible. Thus, small equipment can be used for locations with low generation of waste or using a treatment plant for large quantities (hundreds of tons per day), always making use of the same production methodology. Another great benefit when compared with the traditional composting means, which industrial area requires a space that is several times larger, for storage of the materials and process, apart from the mandatory slurry treatment system, which does not exist in the present case.

In a second aspect, the present patent application refers to the vegetable substrate resulting from said method, which contains from 70% to 80% of organic waste, 5% to 20% of peat, coconut fiber, dry wood chips, sawdust and/or combinations thereof, 2% to 6% of zeolite and 3% to 10% calcium oxide relative to the total weight of the composition.

Differently from the methods of the state of the art, which use calcium oxide as a digestor, the calcium oxide used in the present invention has as main function to delay the decomposing of the waste, thus not allowing the premature loss of all the nutrient material contained in same (for example, nitrogen for the atmosphere; phosphorus, potassium among others in the leachate).

The presence of calcium oxide used in this invention aggregated to the organic waste particles aims at delaying the decomposing of same and will simultaneously avoid the production of odors by the mixture, also avoiding the generation of gases such as methane, harmful to human beings and to the environment, and which normally occur in the traditional composting methods. Once the product has been applied to the soil for fertilization, from the first irrigations and/or in the presence of water, it will gradually transform into calcium carbonate, which, due to having a base character, acts as an acidity corrector in the soil (recurring problem in most of the agricultural soils). In the meantime, by means of the biological processes, a small portion of the organic waste will begin to decompose in the soil due to the transformation of calcium oxide in carbonate, gradually releasing the nutrients contained and preserved in the organic waste, while the plants are developing.

The compression process of the present vegetable substrate will also allow the beginning of the composting of the waste directly in the soil, with slow and gradual release of the nutrients in the soil solution and utilization of same by the cultures, before they are leached. In this case, the longevity of the product is clear and a higher efficiency in the use of the nutrients, when compared to the mineral fertilizers (high concentration and immediate release of nutrients with significant losses by k-leaching, fixation in the p-swap complex or loss by denitrification-n). One further notable advantage, when compared to the organic fertilizers produced by the traditional process (composting piles), since these suffer significant losses of nutrients by leaching and denitrification during the production which takes up to 90 days.

After the calcium oxide hydrolysis in the soil, some quantity of CO₂ will certainly be released in the form of gas, taking into account that a part of the organic waste that was protected by calcium oxide will begin to decompose, as occurs in a traditional composting. However, apart from the fact that this release is slow (comparing, for example, with the incineration treatment), the process of the invention avoids the production of methane which is responsible for approximately 6% of the greenhouse effect.

Due to the high capacity of ionic interchange of zeolite added in the vegetable substrate of the invention and the property thereof of absorbing moisture, the same enhances the efficiency of the fertilizers and reduces the leaching and volatilization of the nutrients. The zeolite also has the property of accumulating the irrigation water, to release it later little by little according to the need of the plant, retaining minerals such as potassium, calcium, magnesium and also nitrogen. This occurs because the plants feed mainly by ionic interchange, and the zeolite does not release the nutrients unless there exists the ionic exchange.

The peat Sphagnum is considered one of the main raw materials for substrates in the world, replacing the soil in cultivation, serving as support for the seedlings and anchor for the roots, and enabling the supply of balanced amounts of air, water and nutrients, as well as the maintenance of the pH levels of the soil and improving the conductance, important effect for the occurrence of the cationic exchange. Its presence in the substrate of the present patent application aims primarily at the maximum retention of water released by the crushed waste, in such manner that this water does not come into contact with the calcium oxide which will aggregate to the organic particles during step (e) of the process, thus avoiding the leaching thereof and consequently leaving the waste free from protection, which would certainly imply in its future and rapid decomposition. In the second place, not only will the water be absorbed by the peat as all the nutrients contained in same. Said nutrients will be subsequently released in the soil gradually, as the maintenance of the fertilizing properties, for a long period of time. This translates into smaller additions of fertilizers during the growth cycle of the plants.

In a third aspect, the present invention foresees the use of the vegetable substrate as a fertilizer with prolonged action, which may be used as base for the planting of the most diverse cultures (from leafy to arboreal), not requiring, occasionally, being reapplied or complemented for a long period of time, for example, longer than five months.

The prolonged-release fertilizer can further be mixed with poor and sandy soils, in a 50%-50% proportion; and may also be used for the planting of vegetables and perennial crops.

Further, the vegetable substrate of the present invention also presents a synergistic effect, as a fertilizer for the gradual release of nutrients and soil acidity corrective.

The correction of the acidity of the soil is necessary to improve the use of the fertilizers and achieve higher productivity of the cultivated plants. When the pH of the soil is increased with the use of the calcium oxide, via leaching, and hydrolysis of the latter, there is an increase in the availability of some nutrients and, at the same time, the insolubilization of others, considered toxic for the plants, such as aluminum and manganese, as well as the increase of the calcium and magnesium contents, in the ionic exchange complex of the soils.

The CO₂ gas resulting from the compression of the calcium oxide will be captured by the soil and remain there until it is used by the cultivated plants. The continued use of the vegetable substrate of the invention promotes an increase of organic matter in the soil, which benefits have long been described, including the improvement in the structure, aggregation, drainage, biology and in a general manner for promoting the increase of productivity.

Particularly, the present substrate is used as compost for reposition of nutrients, with quarterly application, as well as, corrective of the soil acidity for agricultural soils, ideal for the cultivation in vases or greenhouses, due to the physical characteristics (water storage and porosity) and for being free from diseases, harmful plants and biological risks because of the manufacturing process. Further, it can be used as vegetable soil for the planting of the most diverse cultures directly in the product, waiving the need for reposition of nutrients for long periods (up to 18months). The substrate is light and not too dense, which facilitates the transport, handling, application and levelling of the location and planting, being adapted to the agricultural implements already used in the market. Specifically, it is ideal for horticultural activities in rooftops and building slabs, reducing the temperature of the rooms which are below the slab and saving energy from air-conditioning systems. Finally, it is excellent for planting in soils that are not very fertile and even in a sandy substrate (98% SiO₂), in a mixture of 50% of product and 50% sand.

### Comparative Study of the Performance of Organic Fertilizers by Means of the Evaluation of Phenology and Nutritional Parameters of the Corn Culture (Zea mays) and of the Physical-Chemical Characteristics of the Soil

A study was carried out in the corn culture in greenhouse conditions, using the vegetable soil, organic compost (produced by the traditional composting methods—Visafértil®), mineral fertilizer and the prolonged-release vegetable substrate (CEXP), of the present invention.

The purpose of the study was to evaluate the nutritional efficiency and effects as soil conditioner of the prolonged-release vegetable substrate (CEXP) originating from the method of the present invention, compared with the mineral fertilizing and reference organic compost (Visafértil®), in corn culture.

There were evaluated several aspects, among them: the morphology of the plants, the production of dry mass, the nutrient content in the leaves, the physical-chemical characteristics of the soil before and after applying the treatments.

### Method

The experiment was carried out in a common greenhouse (without moisture and/or temperature control). As plant test a commercial hybrid corn was used. Each plot was comprised of vases having 5 dm3 capacity. The soil was completely characterized prior to the implementation of the experiment, determining the contents of macronutrients, micronutrients, organic matter, texture and granulometry. Surface soil was used (collected at 0-10 cm depth), with good fertility, the V % being between 60-80%. The mineral fertilizer was applied also during planting, in a dosage corresponding to the quantity of N supplied by the organic composts and applied at a ratio of 8 t ha-1. For comparison purposes, N was not applied in cover.

The experimental design adopted was entirely randomized, with 2 sources and three dosages, as well as the absolute witness and a control treatment which received traditional mineral fertilization for the culture, all the treatments having 4 repetitions wherein each repetition counted on three vases, amounting to 32 experimental plots and 96 vases. In each vase there were sown, with V2 stage thinning, 3 seeds, maintaining solely one plant per vase.

The experiment was conducted until the plants reached the V10 stage in development.

TREATMENTS:

| Treatments | Description |
|---|---|
| 1 | Absolute witness (control) |
| 2 | Control (mineral |
| | fertilization) |
| 3 | Visafértil 5 t ha⁻¹ |
| 4 | Visafértil 8 t ha-1 |
| 5 | Visafértil 10 t ha⁻¹ |
| 6 | CEXP 5 t ha⁻¹ |
| 7 | CEXP 8 t ha⁻¹ |
| 8 | CEXP 10 t ha⁻¹ |

QUALIFICATION OF ORGANIC COMPOSTS:

| | | CEXP | Visafértil ® | units |
|---|---|---|---|---|
| pH | | 7.9 | 8.24 | |
| nitrogen | (N) | 7.70 | 7.20 | g/Kg |
| | | 0.77 | 0.72 | % |
| phosphorus | Total (P) | 1870 | 10900 | mg/kg |
| | | 0.19 | 1.09 | % |
| phosphorus | (CNA) | 625 | ND | mg/Kg |
| | | | | (ppm) |
| phosphorus | (H2O) | 45 | ND | mg/Kg |
| | | | | (ppm) |
| phosphorus | Insoluble | 1200 | ND | mg/Kg |
| | | 64% | | (ppm) |
| potassium | (K) | 7.17 | 11.70 | g/Kg |
| | | 0.72 | 1.17 | % |
| calcium | (Ca) | 79.25 | 28.90 | g/Kg |
| | | 7.93 | 2.89 | % |
| magnesium | (Mg) | 2.87 | 2.70 | g/Kg |
| | | 0.29 | 0.27 | % |
| sulfur | (S) | 2.25 | 1.90 | g/Kg |
| | | 0.23 | 0.19 | % |
| sodium | (Na) | 4.25 | 1.61 | g/Kg |
| | | 0.43 | 0.16 | % |
| organic | | 20.55 | 20.25 | % |
| carbon | | | | |
| c/n relation | | 26/1 | 16/1 | % |
| Moisture | (U) | 15.75 | 54.80 | % |

### Evaluations

The evaluations were carried out in three culture stages namely, V4, V7 and V10, when 50% of the plants reached the referred vegetative stages.

After conclusion of the evaluation phase in the greenhouse, a collection of leaves was carried out and whole plant from all the plots; these samples were sent to the specialized laboratory for analyses. Collections were also made from compost samples of the treatment soils, for comparison of the fertility parameters thereof, before and after the application of the products, as well as the weighing of the roots.

In v4 and v7 and v10, there was carried out a visual evaluation of the initial vigor of the plants, attributing points from 0 to 5 for coloring, vigor and bearing, as well as the observation of possible symptoms of deficiency and/or toxicity of some element (abiotic stress). Further, the height of these plants was measured.

There were collected in all plots the 10th completely open leaf. The samples were sent to a qualified laboratory to carry out the analysis of the nutrient contents (macro and micro).

For the evaluation of the dry matter of the aerial part—the plants were cut at soil level, and after kiln drying, the weighing was carried out, defining the quantity of dry matter;

The soil from all the vases was sifted and the roots separated for the purposes of evaluation of the weight of the roots.

The soil was individually sampled in each plot for a new analysis, to determine differences in their fertility parameters (before and after the treatments)

RESULTS: EFFECT ON THE VIGOR OF THE PLANTS
(SCALE FROM 1-5)

| | | | May 7, | May 29, | Jun. 17, |
|---|---|---|---|---|---|
| | | Dose | 2019 | 2019 | 2019 |
| No. | Treatment | (kg ha⁻¹) | V4 | V7 | V10 |
| 1 | Witness (control) | — | 2.0¹b² | 2.0 b | 2.0 b |
| 2 | Mineral fertilizer | 1000 | 5.0 a | 5.0 a | 5.0 a |
| 3 | Visafértil | 5000 | 2.3 b | 2.3 b | 2.3 b |
| 4 | Visafértil | 8000 | 2.0 b | 2.0 b | 2.0 b |
| 5 | Visafértil | 10000 | 2.5 b | 2.5 b | 2.8 b |
| 6 | CEXP | 5000 | 2.3 b | 2.3 b | 2.3 b |
| 7 | CEXP | 8000 | 2.3 b | 2.3 b | 2.3 b |
| 8 | CEXP | 10000 | 2.5 b | 2.5 b | 2.8 b |

| | | | |
|---|---|---|---|
| CV (%) | 15.56 | 15.53 | 15.16 |
| Tukey D.M.S. (P = 0. 05) | 0.96 | 0.96 | 0.96 |
| Prob (F) | 0.12 | 0.12 | 0.87 |
| Standard deviation | 0.40 | 0.40 | 0.40 |

¹real data.
²in the columns, averages followed by the same letter do not differ from each other by Tukey (P = 0. 05) .

### Height of the Plants

The prolonged-release vegetable substrate (CEXP) promoted greater plant development in comparison with the Visafértil®, and the 8 t/ha dose compared statistically to the control treatment with mineral fertilizer, in the evaluations V7 and V10.

In the smaller dosage (5 t/ha) the prolonged-release vegetable substrate (CEXP) compared to the Visafértil® in the maximum dosage (10 t/ha) in evaluation in V4 at a dosage of 8 t/ha in V7 and V10, corroborating a greater efficiency of up to 100% of the prolonged-release vegetable substrate (CEXP) to the equivalent dosage.

### Vigor of the Plants

The treatments with organic composites did not show vigor that is comparable to the mineral fertilization and did not differ from each other.

### Weight of the Roots—Dry Matter

The prolonged-release vegetable substrate (CEXP) showed a greater development of the roots at the dosage of 5 t/ha, when compared with the product Visafértil® in the same dosage. The latter promoted a result similar only to 8 t/ha.

However, there was observed an antagonist effect in the root mass with the increase of the dosage of the prolonged-release vegetable substrate (CEXP). There was observed a linear tendency to mass reduction with the dosages of 8 and 10 t/ha.

The 10 t/ha dosage also promoted a lower result than the absolute witness (without any fertilization).

### Nutrient Content in Foliar Tissue

### Potassium (K)

The treatments with the prolonged-release vegetable substrate (CEXP) promoted significant increase of the foliar K content, surpassing even the mineral fertilizer formulation. A slow-release effect of the nutrient in the soil can be inferred and with this a better use by the plants, since the K concentration in the mineral fertilizer is several times superior to that of the CEXP.

### Calcium (CA)

Both organic compounds were able to produce equivalent contents of Ca in the foliar tissue, and to the 8 t/ha dosage, the content was statistically similar to the mineral fertilizer, however similar to the witness.

### Boron (B)

The prolonged-release vegetable substrate (CEXP) was remarkably efficient in supplying B to the plants. At the lower dosage it was already significantly superior to the Visafértil® at 5 and 8 t/ha.

The Visafértil® only at 10 t/ha was statistically equivalent to the result of the lowest dosage of the prolonged-release vegetable substrate (CEXP).

As expected, both the witness, as the mineral fertilizer obtained lower results for B, equivalent to Visafértil® at 5 and 8 t/ha.

### Zinc (ZN)

As expected, the organic compounds promoted an increase of Zn in the foliar tissue when compared to the witness and to the mineral fertilizer, since it is an NPK formulation, without the addition of micronutrients;

At dosages of 5 and 10 t/ha, the prolonged-release vegetable substrate (CEXP) differed statistically from the witness and the mineral fertilizer, which did not occur with the Visafértil® at any dosage.

### Effect on the Soil Fertility

### PH-CACL₂

The prolonged-release vegetable substrate (CEXP) due to its base character, promoted a clear increase in the pH of the soil. This shows the corrective/soil improvement character, since in a general manner the soils are acid, which as a rule constitutes a fertility problem;

It is noted that the dosages of 8 and 10 t/ha differed statistically from the remaining treatments causing an elevation of the pH of nearly 1 point, and within the ideal range. The same behavior was not observed for the product Visafértil®, although this also differed from the witness, however, only in the highest dosages.

The Visafértil® only at 8 and 10 t/ha was statistically equivalent to the result of the lower dosage of CEXP.

### Bases (CA, K And MG)

The prolonged-release vegetable substrate (CEXP), in a general manner, was able to promote a significant increase in the content of the soil bases. In a certain way corroborating, for example, with the increase in the K content in the foliar tissue, as previously pointed out.

The sum of the bases showed itself to be significantly higher for CEXP at 5 t/ha when compared with the product Visafértil® at 5 and even at 10t/ha.

### Cationic Exchange Capacity (CTC)

The CTC was positively impacted by the use of both organic compounds, as expected by its content in organic matter, however, they were statistically similar to each other.

### Effect on the Soil Fertility

### Sodium (NA)

A slight increase in the Na content in the soil was noted with the use of the prolonged-release vegetable substrate (CEXP) in the three dosages. In normal use conditions and in light of the data of this experiment, no harmful effect was observed in the soil or plants.

### Phosphorus (P₂O₅)

Although statistically similar, the prolonged-release vegetable substrate (CEXP) and the product Visafértil® were efficient in increasing the P content in the soil relative to the witness.

The mineral fertilizer presented a better result for P, differing from all the treatments by presenting high concentration of the referred nutrient.

### Saturation Per Bases (V %)

The prolonged-release vegetable substrate (CEXP) at 5 t/ha was statistically superior to the Visafértil® at 5 and 10 t/ha, also was distinct from the witness and the mineral fertilizer, naturally.

The application of the prolonged-release vegetable substrate (CEXP) increased the saturation per bases in nearly 20%, showing once more the improvement/soil corrective character thereof.

### Conclusions

The prolonged-release vegetable substrate (CEXP) promoted more height to the plants, when compared with the reference compound (Visafértil®), in proportionally lower dosages, although it did not promote similar development in the plants than the mineral fertilizer.

The prolonged-release vegetable substrate (CEXP) at a dosage of 5 t/ha promoted greater root development, when compared with the reference compound (Visafértil®), at the same dosage, being also superior to the standard.

The prolonged-release vegetable substrate (CEXP) in a broad manner, promoted the improvement of the nutritional state of the plants, contributing to the increase of the content of Ca, K, B and Zn in the foliar tissue, with emphasis on B and K, presenting superior results to the reference compound (Visafértil®) and to the mineral fertilizer, which corroborates the slow-release characteristic of the nutrients and of the preservation thereof during the manufacturing process.

The prolonged-release vegetable substrate (CEXP) demonstrated a potential for use as improver/soil corrective by the pH increase, cation exchange capacity (ctc), sum of bases and, therefore, v %; which effect naturally was not observed in mineral fertilization.

The prolonged-release vegetable substrate (CEXP) promoted a significant increase in the Na content in the soil. Effect not observed in the remaining treatments.

1. A method of manufacturing a vegetable substrate, the method comprising:
(a) selecting, separating and prepreparing organic waste, before beginning the process of decomposing of the referred waste, and with moisture content from 50% to 70%;
(b) reducing moisture of the organic waste to 15%;
(c) adding from 5% to 20% of the total weight of peat, coconut fiber, dry wood chips, sawdust and/or the combinations thereof to the waste of (b) at a temperature from 80° C. to 110° C. and stirring between 40 to 60 RPM for 20 to 40 minutes;
(d) crushing of the mixture of (c) in quantities of 70% to 80% of the total weight of the composition in a granulometry between 1 mm to 30 mm;
(e) adding 2% to 6% of zeolite and 3% to 10% of calcium oxide relative to the total weight of the composition, repeating the steps of mixing, stirring, heating and homogenization of (c) and (d), and
(f) cooling and drying for one to 4 hours at room temperature.

2. The method according to claim 1, wherein the organic waste comprises waste selecting from the group consisting of food remains, vegetable waste, tree pruning, gardening waste, food industry processing waste, meat, bones, and excrements from animals.

3. The method according to claim 1, wherein the organic waste selected being used between 48 hours and 72 hours from the selection and separation thereof.

4. The method according to claim 3, wherein the organic waste used after 48 hours from the selection and separation being stored under refrigeration with temperature between 2° C. and 6° C.

5. The method according to claim 1, wherein the reduction of moisture in (b) is obtained by means of the utilization of an equipment comprising a tank with capacity to homogenize and stir the mixture by means of rotary blades, and heating by means of a heat exchanger with temperature controlled between 80° C. to 110° C.

6. The method according to claim 1, wherein (c) comprising adding peat, coconut fiber, dry wood chips, sawdust and/or combinations thereof carried out in an internal fixed tank with rotary blades and programmed for reversal of the rotary direction every 10 minutes.

7. The method according to claim 6, wherein the mixture results from (c) being stirred and mixed continuously in the tank for 20 to 40 minutes, at a speed from 40 RPM to 60 RPM and at a temperature of 90° C.

8. The method according to claim 6, wherein (c) further comprises removing water steam generated inside the tank by employing an extractor.

9. The method according to claim 1, wherein crushing in (d) is carried out by an equipment with parallel blades or other types of crushers and/or grinders of organic waste.

10. The method according to claim 1, wherein the zeolite added in (e) comprises 3% of the total composition in powder form.

11. The method according to claim 1, wherein the calcium oxide added in (e) comprises 8% of the total composition in powder form.

12. The method according to claim 1, wherein the total cycle for the manufacture of the said substrate being of three hours.

13. A prolonged release vegetable substrate, obtained by means of the method of claim 1, wherein the substrate produced from 70% to 80% or organic waste, 5% to 20% of peat, coconut fiber, dry wood chips, sawdust and/or the combinations thereof, 2% to 6% of zeolite and 3% to 10% of calcium oxide relative to the total weight of the composition.

14. The substrate according to claim 13, wherein the substrate formed from compression originating from the addition of calcium oxide, peat, coconut fiber, dry wood chips, sawdust and/or combinations thereof and zeolite.

15. The substrate of claim 13, wherein the substrate is adapted for prolonged-release fertilizer and for correction of the acidity of the soil for planting of cultures, such as, foliages and arboreal, not requiring to be reapplied or complemented for a period longer than five months.

16. The substrate according to claim 15, wherein the substrate is adapted for poor and sandy soils in a 50%-50% proportion; further being capable of being used for the planting of vegetables and perennial cultures.

17. The substrate according to claim 15, wherein the substrate increases the availability of potassium (K); sodium (Na); boron (B); zinc (Zn); and nitrogen (N), as well as the insolubilization of phosphorus (P), aluminum (Al) and manganese (Mn) and the increase of the calcium (Ca) and magnesium (Mg) contents, in the ionic exchange complex of the soils.

18. The substrate according to claim 15, wherein the substrate is adapted to promote an increase of the organic matter of the soil, including the improvement in the structure, aggregation, drainage, biology and for promoting the increase of productivity.

19. The substrate according to claim 15, wherein the substrate forming fertilizer for nutrient reposition.

20. The substrate of claim 15, forming vegetable soil for the planting of cultures directly in the product, waiving the need for nutrient reposition for long periods of up to 18 months.

21. The substrate of claim 15, adapted for horticulture in rooftops and building slabs.

22. The substrate of claim 15, adapted for planting in soils that are not too fertile and even in sandy substrate containing 98% SiO₂.
